(19) United States
(12) Patent Application Publication
(10) Pub. No.: US 2022/0266518 A1
(43) Pub. Date: Aug. 25, 2022

(54) CLEANING OF ADDITIVELY MANUFACTURED OBJECTS BY VACUUM CYCLING NUCLEATION

(71) Applicant: Carbon, Inc., Redwood City, CA (US)

(72) Inventors: Stephen J. Peter, San Francisco, CA (US); Kristen Einthoven, Redwood City, CA (US); Bob E. Feller, San Mateo, CA (US); Michael Murillo, Menlo Park, CA (US)

(21) Appl. No.: 17/637,930

(22) PCT Filed: Sep. 18, 2020
(86) PCT No.: PCT/US2020/051485

§ 371 Date: Feb. 24, 2022

Related U.S. Application Data
(60) Provisional application No. 62/903,118, filed on Sep. 20, 2019.

(51) Int. Cl. B29C 64/35; B08B 3/08; B08B 3/12; B08B 3/14; B33Y 10/00; B33Y 40/20; B33Y 50/00; B29C 64/386

(52) U.S. Cl. CPC B29C 64/35; B08B 3/08; B08B 3/12; B08B 3/14; B33Y 10/00; B33Y 40/20; B33Y 50/00; B29C 64/386; B08B 2203/007; B08B 2220/04; B29K 2075/00

(57) ABSTRACT

A method of making an object from a data file and a light polymerizable resin by additive manufacturing includes the steps of: (a) optionally modifying the data file to add additional vacuum cycling nucleation (VCN) nucleation sites to surfaces of the object (2A); (b) producing the object from the data file and the resin by light polymerization in an additive manufacturing process (3), optionally under conditions in which additional VCN nucleation sites are added to surfaces of the object, the object having residual resin adhered to the surface thereof; and then (c) cleaning the residual resin from the object with a wash liquid by vacuum cycling nucleation (4).

### RELATED APPLICATIONS

This application claims the benefit of and priority from U.S. Provisional Application Ser. No. 62/903,118, filed Sep. 20, 2019, the disclosure of which is hereby incorporated by reference in its entirety.

### FIELD OF THE INVENTION

The present invention concerns methods of producing and cleaning objects by additive manufacturing, particularly objects produced by stereolithography.

### BACKGROUND OF THE INVENTION

A group of additive manufacturing techniques sometimes referred to as “stereolithography” creates a three-dimensional object by the sequential polymerization of a light polymerizable resin. Such techniques may be “bottom-up” techniques, where light is projected into the resin on the bottom of the growing object through a light transmissive window, or “top down” techniques, where light is projected onto the resin on top of the growing object, which is then immersed downward into the pool of resin.

The recent introduction of a more rapid stereolithography technique known as continuous liquid interface production (CLIP), coupled with the introduction of “dual cure” resins for additive manufacturing, has expanded the usefulness of stereolithography from prototyping to manufacturing (see, e.g., U.S. Pat. Nos. 9,211,678; 9,205,601; and U.S. Pat. No. 9,216,546 to DeSimone et al.; and also in J. Tumbleston, D. Shirvanyants, N. Ermoshkin et al., Continuous liquid interface production of 3D Objects, Science 347, 1349-1352 (2015); see also Rolland et al., U.S. Pat. Nos. 9,676,963, 9,453,142 and 9,598,606).

Wash liquids and wash apparatus for additively manufactured objects, including those made from dual cure resins prior to their second cure, are known and described in, for example, U.S. Pat. No. 10,343,331 to McCall, Rolland, and Converse, and PCT Patent Application Pub. No. WO 2018/111548 to Converse, Powell et al. These are satisfactory for many objects. However, some objects—such as those with small features or channels that trap the highly viscous resins from which they are made—are cleaned slowly by such systems. Where the objects are “green” objects made from a dual cure resin and contain as-yet unpolymerized constituents, more aggressive cleaning can be deleterious. Accordingly, there remains a need for new wash techniques in additive manufacturing.

### SUMMARY OF THE INVENTION

Unlike other forms of 3d printing such as selective laser sintering and fused deposition modeling, additive manufacturing in which the object is formed from a light-polymerizable resin (typically referred to as “stereolithography”) result in objects coated with a viscous, and often partially polymerized, residual resin liquid. We have found that such residual resin can be effectively removed by vacuum cycling nucleation (VCN). The surfaces of the objects can advantageously be modified by several techniques to create additional nucleation sites that facilitate cleaning of the object during VCN. Where dual cure resins are used (that is, resins that produce “green” intermediate objects for further curing, such as by baking) the VCN cleaning step is not unduly damaging to the chemical composition of the green intermediate object, and the VCN cleaned intermediate objects can be further cured to produce finished objects having satisfactory mechanical properties.

Some embodiments of the present invention are directed to a method of making an object from a data file and a light polymerizable resin by additive manufacturing. The method includes the steps of: (a) optionally (but in some embodiments preferably) modifying the data file to add additional vacuum cycling nucleation (VCN) nucleation sites to surfaces of the object; (b) producing the object from the data file and the resin by light polymerization in an additive manufacturing process (e.g., stereolithography), optionally (but in some embodiments preferably) under conditions in which additional VCN nucleation sites are added to surfaces of the object, the object having residual resin adhered to the surface thereof; and then (c) cleaning the residual resin from the object with a wash liquid (e.g., an aqueous wash liquid or a wash liquid including an organic solvent) by vacuum cycling nucleation (e.g., at least one cycle of VCN, and in some embodiments 2 or 3 cycles of VCN to 10, 20 or 30 cycles of VCN).

In some embodiments, the object includes a lattice (e.g., an interconnected strut lattice, a surface lattice, particularly triply period surface lattices such as a Schwarz-P surface lattice, an F-RD surface lattice, etc.)

In some embodiments, the object includes a fluid flow conduit (e.g., microfluidic devices, manifolds, fluid connectors, etc.), or an electrical connector.

In some embodiments, the producing step is carried out with the object adhered to a carrier platform, and the cleaning step is carried out with the object adhered to the carrier platform without intervening separation therefrom.

In some embodiments, the cleaning step includes: (i) immersing the object in the wash liquid and subjecting the object to VCN; (ii) separating the wash liquid from the object, and then optionally subjecting the object to a vacuum and/or heat, to and at least partially dry the object; and then (iii) cyclically repeating steps (i) and (ii) until the object is cleaned.

In some embodiments, immersing of the object in wash liquid and/or separating of the wash liquid from the object is carried out by gravity draining, pumping, forcing with a pressurized gas (air, nitrogen, etc.), pulling with a vacuum, or a combination thereof.

In some embodiments, the cleaning step includes agitating the wash liquid (e.g., with a sonicator such as an ultrasound transducer).

In some embodiments, the wash liquid is at least partially saturated with carbon dioxide sufficiently to enhance bubble formation during VCN.

In some embodiments, the method further includes heating the object prior to the cleaning step, subjecting the object to increased pressure prior to the cleaning step, and/or heating the wash liquid for initial contact with the object during the cleaning step, to facilitate separation of resin from the object during the cleaning step.

In some embodiments, the cleaning step is carried out in a time of from 5 or 10 seconds or 1 minute, up to 2, 5, 10 or 20 minutes (i.e., as measured from initiation of the first immersing step, to completion of the final separating step).

In some embodiments, the producing step is carried out by bottom-up stereolithography (e.g., continuous liquid interface production or “CLIP”, optionally with at least a portion of the object being produced in reciprocal mode to impart additional VCN nucleation sites to surfaces of the object), top-down stereolithography, rolling film 3d printing, or multi-jet fusion 3d printing.

In some embodiments, the object is produced from a dual cure resin, the dual cure resin resin including a mixture of (i) a light polymerizable liquid first component, and (ii) a second solidifiable component that is different from said first component; and the method further includes the step, after said cleaning step, of: (d) further curing the object (e.g., by heating, microwave irradiating, or a combination thereof).

In some embodiments, the first component includes monomers and/or prepolymers including reactive end groups selected from the group consisting of acrylates, methacrylates, □-olefins, N-vinyls, acrylamides, methacrylamides, styrenics, epoxides, thiols, 1,3-dienes, vinyl halides, acrylonitriles, vinyl esters, maleimides, and vinyl ethers.

In some embodiments, the second solidifiable component includes the precursors to a cyanate ester resin, and wherein the wash liquid includes an organic solvent (e.g., an alcohol, such as isopropanol, propylene glycol, or a combination thereof).

In some embodiments, the second solidifiable component includes the precursors to an epoxy resin, and wherein the wash liquid includes an organic solvent (e.g., a dibasic ester such as a dimethyl ester of adipic acid; an ether; an alcohol such as isopropanol, propylene glycol, or a combination thereof).

In some embodiments, the second solidifiable component includes the precursors to a polyurethane, polyurea, or copolymer thereof, and the wash liquid includes an organic solvent (e.g., an ether; an alcohol such as isopropanol, propylene glycol, or a combination thereof; etc.).

In some embodiments, the wash liquid includes: (i) at least 50 percent by volume isopropanol (e.g., in combination with up to 50 percent by volume water); (ii) at least 20 or 40 percent by volume of a halogenated organic solvent (e.g., a hydrofluorocarbon solvent), in combination with up to 60 or 80 percent by weight of additional aqueous and/or organic solvents.

In some embodiments, the method further includes, following the cleaning step, the step of: (e) distilling said wash liquid to produce a recycled wash liquid, and repeating step (c) with subsequently produced objects with said distilled wash liquid.

Some other embodiments of the present invention are directed to a vacuum cycling nucleation cleaning apparatus, including: (a) a wash chamber; (b) a wash liquid reservoir; (c) a wash liquid transfer line interconnecting the wash chamber and the wash liquid reservoir, the transfer line having a control valve operatively associated therewith; (d) a vacuum source operatively associated with the wash chamber; (e) a stereolithography build platform engagement member operatively associated with the wash chamber and configured to releasably engage a build platform, the build platform having a unique identifier connected thereto; (e) a unique identifier reader operatively associated with the wash chamber and positioned to communicate with said unique identifier.

In some embodiments, the reservoir has an agitator operatively associated therewith (e.g., to prevent residual resin such as a dual cure resin previously removed from objects from separating from said wash liquid).

In some embodiments, wash liquid contact surfaces of the wash chamber, the wash liquid reservoir, the wash liquid transfer line, the said control valve comprise a fluoropolymer surface coating to reduce the adhesion thereto of residual resin (e.g., dual cure resins) carried by the wash liquid.

The foregoing and other objects and aspects of the present invention are explained in greater detail in the drawings herein and the specification set forth below. The disclosures of all United States patent references cited herein are to be incorporated herein by reference.

### BRIEF DESCRIPTION OF THE DRAWINGS

FIG. 1 shows one embodiment of a process for producing an object by additive manufacturing and cleaning that object by VCN.

FIG. 2 shows a second embodiment of a process for producing an object by additive manufacturing and cleaning that object by VCN.

FIG. 3a-c show various views of a Schwarz P triply period surface lattice, which can be produced by additive manufacturing and cleaned by VCN as described herein.

FIGS. 4a-c show various views of an F-RD triply period surface lattice unit cell, which may be included in an additively manufactured lattice object produced and cleaned by VCN as described herein.

FIG. 5 schematically illustrates on embodiment of an apparatus for carrying out VCN on an additively manufactured object.

### DETAILED DESCRIPTION OF ILLUSTRATIVE EMBODIMENTS

The present invention is now described more fully hereinafter with reference to the accompanying drawings, in which embodiments of the invention are shown. This invention may, however, be embodied in many different forms and should not be construed as limited to the embodiments set forth herein; rather these embodiments are provided so that this disclosure will be thorough and complete and will fully convey the scope of the invention to those skilled in the art.

“Unique identifier” and “identifier reader” as used herein refer to components of an automatic identification and data capture system. Suitable unique identifiers include, but are not limited to, bar codes (including one-dimensional and two-dimensional bar codes), near field communication (NFC) tags, radio frequency identification (RFID) tags (including active, passive, and battery-assisted passive RFID tags), optical character recognition (OCR) tags and readers, magnetic strips and readers, etc.

As used herein, the term “and/or” includes any and all possible combinations of one or more of the associated listed items, as well as the lack of combinations when interpreted in the alternative (“or”).

### 1. Resins and Additive Manufacturing Steps.

As noted above, the processes described herein are useful for a variety of objects, including objects comprising lattices, objects with complex inner cavities, objects with textured surfaces, objects having blind blind corners or turns therein, objects with large surface-to-mass ratios, objects with sharp radii, objects with dimpled surfaces, etc. as well as objects comprised of materials that benefit from a shorter solvent exposure time and/or more gentle handling than typically imparted during other cleaning processes such as centrifugal separation or conventional washing.

Resins for additive manufacturing are known and described in, for example, U.S. Pat. Nos. 9,211,678; 9,205,601; and U.S. Pat. No. 9,216,546 to DeSimone et al. In addition, dual cure resins useful for carrying out some embodiments of the present invention are known and described in U.S. Pat. Nos. 9,676,963, 9,453,142 and 9,598,606 to Rolland et al., and in U.S. Pat. No. 10,316,213 to Arndt et al. Thus, in some embodiments, the objects may be “green intermediate” objects comprised of at least one precursor to a polyurethane, polyurea, epoxy, cyanate ester, or silicone polymer, or combination thereof, prior to subsequent curing (e.g., by heating and/or microwave irradiating).

Particular examples of suitable dual cure resins include, but are not limited to, Carbon Inc. medical polyurethane, elastomeric polyurethane, rigid polyurethane, flexible polyurethane, cyanate ester, epoxy, and silicone dual cure resins, all available from Carbon, Inc., 1089 Mills Way, Redwood City, Calif. 94063 USA.

Suitable additive manufacturing methods and apparatus are known and include bottom-up and top-down additive manufacturing, generally known as stereolithography. Such methods are known and described in, for example, U.S. Pat. No. 5,236,637 to Hull, U.S. Pat. Nos. 5,391,072 and 5,529,473 to Lawton, U.S. Pat. No. 7,438,846 to John, U.S. Pat. No. 7,892,474 to Shkolnik, U.S. Pat. No. 8,110,135 to El-Siblani, U.S. Patent Application Publication No. 2013/0292862 to Joyce, and US Patent Application Publication No. 2013/0295212 to Chen et al. The disclosures of these patents and applications are incorporated by reference herein in their entirety. Additional examples of suitable additive manufacturing methods employing light polymerizable resins include, but are not limited to, rolling film 3d printing, multi-jet fusion 3d printing (e.g., Objet U.S. Pat. No. 6,259,962), and the like.

In some embodiments, the additive manufacturing step is carried out by one of the family of methods sometimes referred to as as continuous liquid interface production (CLIP). CLIP is known and described in, for example, U.S. Pat. Nos. 9,211,678; 9,205,601; 9,216,546; and others; in J. Tumbleston et al., Continuous liquid interface production of 3D Objects, Science 347, 1349-1352 (2015); and in R. Janusziewcz et al., Layerless fabrication with continuous liquid interface production, Proc. Natl. Acad. Sci. USA 113, 11703-11708 (Oct. 18, 2016). Other examples of methods and apparatus for carrying out particular embodiments of CLIP include, but are not limited to: Batchelder et al., US Patent Application Pub. No. US 2017/0129169 (May 11, 2017); Sun and Lichkus, US Patent Application Pub. No. US 2016/0288376 (Oct. 6, 2016); Willis et al., US Patent Application Pub. No. US 2015/0360419 (Dec. 17, 2015); Lin et al., US Patent Application Pub. No. US 2015/0331402 (Nov. 19, 2015); D. Castanon, S Patent Application Pub. No. US 2017/0129167 (May 11, 2017). B. Feller, US Pat App. Pub. No. US 2018/0243976 (published Aug. 30, 2018); M. Panzer and J. Tumbleston, US Pat App Pub. No. US 2018/0126630 (published May 10, 2018); and K. Willis and B. Adzima, US Pat App Pub. No. US 2018/0290374 (Oct. 11, 2018).

### 2. Vacuum Cycling Nucleation (VCN) Methods and Apparatus

VCN is a process in which an object to be cleaned is placed in a closed chamber and immersed in a solvent or wash liquid therein. A vacuum is drawn on the chamber to below the vapor pressure of the wash liquid and causes vapor bubbles to form (nucleate) on surfaces of the object. This facilitates the separation of undesired material from the part surfaces. The vacuum is then reduced (or pressure added) sufficiently to collapse the bubbles, causing the wash liquid to flow back to the surfaces. The foregoing cycle is then typically repeated until the desired level of cleaning is obtained. VCN and apparatus for carrying out the same is known and described in, for example, U.S. Pat. Nos. 5,240,507; 5,469,876; 5,538,025 and 6,004,403 to Gray and Beghard, and in U.S. Pat. No. 6,418,942 to Gray and Frederick, the disclosures of which are incorporated by reference herein in their entirety.

### 3. VCN Cleaning of Additively Manufactured Objects.

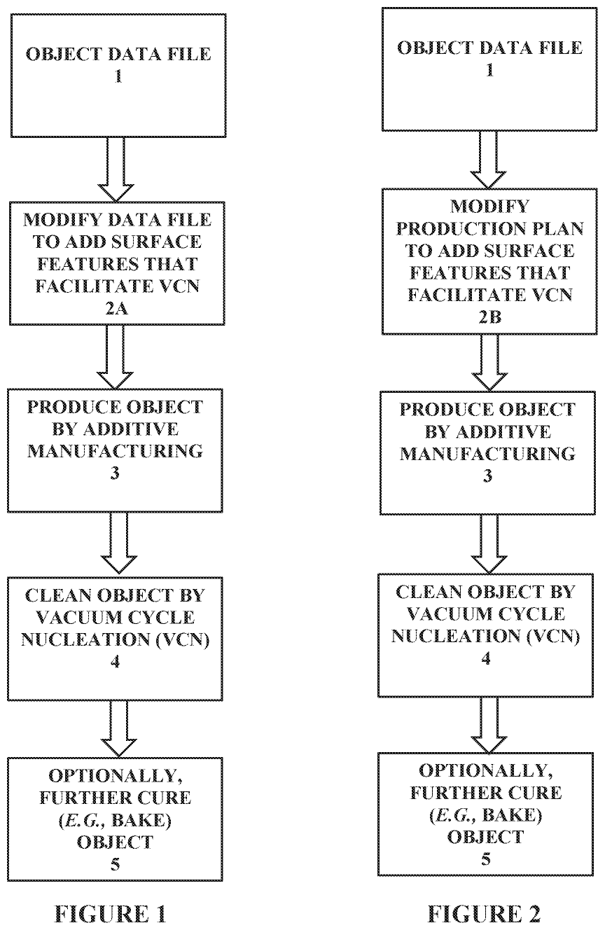

FIGS. 1-2 illustrate particular embodiments of the present disclosure, in which an object data file such as a .stl file (1) is used to produce an object by additive manufacturing (3), which object is then cleaned by VCN (4). When the object is a “green” intermediate produced from a dual cure resin (described above), the object, after cleaning, is then further cured (5) typically by baking, as discussed further below.

As noted in FIG. 1, in some embodiments, the object data file can be modified (2A) to incorporate surface features or surface texture on the object during additive manufacturing thereof. The features or texture can be configured to provide additional nucleation sites for VCN. Such features or texture can be added to the object data file by any suitable technique, including but not limited to those set forth in Ruwen Liu, Efficient surface texturing of objects produced by additive manufacturing, PCT Patent Application Pub. No. WO 2019/0829269 (9 May 2019). For example, conical and rectangular cavities, or any axisymmetric cavity geometry, can be added. Geometries can be optimized or tuned by modifying the angles, depths, heights, lengths, and radii of these geometries. These cavities can also take the forms of wells and grooves that can run the entire or partial length of surface. Geometries having terminations of relatively sharp corners, with angles typically less than or equal to 90 degrees, can be used. Additionally, suitable cavities include those where the surface area to volume ratio is high. Another geometric strategy would be to form artificial dead-ends inside corners or cavities. These dead ends typically terminate in a geometry whose corners are sharp, where nucleation can be promoted.

As noted in FIG. 2, in some embodiments, the stereolithography process itself can be modified (2B), if necessary, to impart surface features or texture to the object that facilitate VCN, whether or not the data file has been modified to impart such surface features. Parameters that can be modified to add surface roughness or features that provide VCN nucleation sites include, but are not limited to, speed and/or pattern of platform movement, dwell time, UV exposure that effects overcure and throughcure, etc. For example, when the stereolithography is carried out by any of the family of bottom-up stereolithography methods referred to as “CLIP” above, the process can be carried out in a “reciprocal” or “pumped” mode, for at least a portion of the object's production, to as described in U.S. Pat. No. 10,391,711 to Sutter et al.

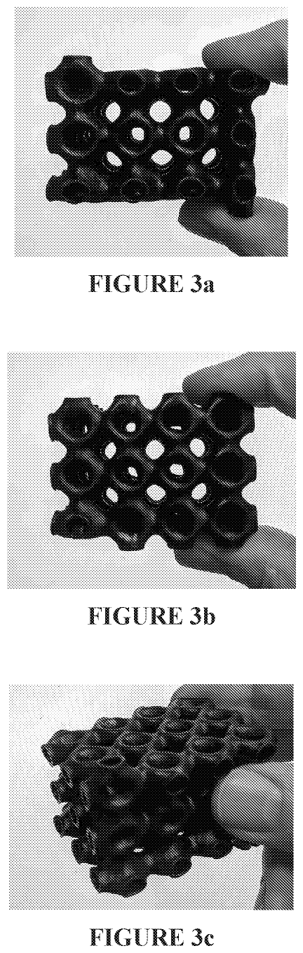

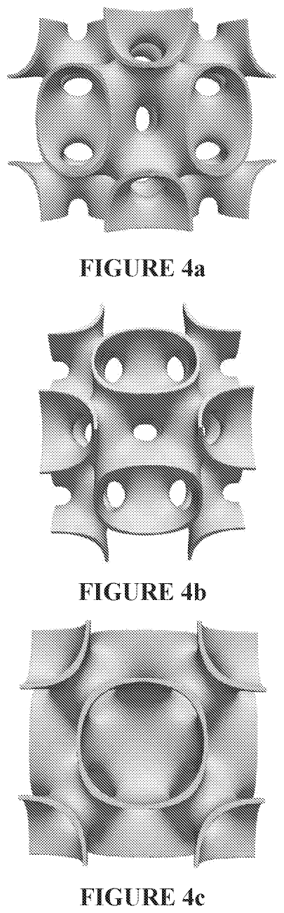

Objects of any configuration can be produced and cleaned by the methods described herein. In some embodiments, the objects comprise lattices (that is, regular or irregular open cell lattices). The lattices can be created from an assembly of interconnected struts, such as those lattices shown in U.S. Pat. No. 10,384,394 to McCluskey and US Patent Application Publication No. US 2018/0271213 to Perrault et al. In other cases, the lattices can comprise surface lattices, including triply periodic surface lattices, such as a lattice of repeating unit cells of a Schwarz P surface lattice (as shown in FIGS. 3a-3c), or a lattice of repeating unit cells of an R-FP surface lattice (individual cell shown in FIG. 4a-4c). Note that such lattices can have surfaces on both sides of the external surfaces, as well as internal surfaces thereof.

Wash liquids that may be used to carry out the present invention include, but are not limited to, water, organic solvents, inorganic nonaqueous solvents, and combinations thereof (e.g., combined as co-solvents), optionally containing additional ingredients such as surfactants, detergents, chelants (ligands), enzymes, borax, dyes or colorants, fragrances, etc., including combinations thereof. The wash liquid may be in any suitable form, such as a solution, emulsion, dispersion, etc.

Examples of organic solvents that may be used as a wash liquid, or as a constituent of a wash liquid, include, but are not limited to, alcohol, ester, dibasic ester, ketone, acid, aromatic, hydrocarbon, ether, dipolar aprotic, halogenated, and base organic solvents, including combinations thereof. Solvents may be selected based, in part, on their environmental and health impact (see, e.g., GSK Solvent Selection Guide 2009).

Examples of alcohol organic solvents that may be used in the present invention include, but are not limited to, aliphatic and aromatic alcohols such as 2-ethyl hexanol, glycerol, cyclohexanol, ethylene glycol, propylene glycol, di-propylene glycol, 1,4-butanediol, isoamyl alcohol, 1,2-propanediol, 1,3-propanediol, benzyl alcohol, 2-pentanol, 1-butanol, 2-butanol, methanol, ethanol, t-butanol, 2-propanol, 1-propanol, 2-methoxyethanol, tetrahydrofuryl alcohol, benzyl alcohol, etc., including combinations thereof. In some embodiments, a C1-C6 or C1-C4 aliphatic alcohol, such as isopropanol, is preferred.

Examples of ester organic solvents that may be used to carry out the present invention include, but are not limited to, t-butyl acetate, n-octyl acetate, butyl acetate, ethylene carbonate, propylene carbonate, butylenes carbonate, glycerol carbonate, isopropyl acetate, ethyl lactate, propyl acetate, dimethyl carbonate, methyl lactate, ethyl acetate, ethyl propionate, methyl acetate, ethyl formate etc., including combinations thereof.

Examples of dibasic ester organic solvents include, but are not limited to, dimethyl esters of succinic acid, glutaric acid, adipic acid, etc., including combinations thereof.

Examples of ketone organic solvents that may be used to carry out the present invention include, but are not limited to, cyclohexanone, cyclopentanone, 2-pentanone, 3-pentanone, methylisobutyl ketone, acetone, methylethyl ketone, etc., including combinations thereof.

Examples of acid organic solvents that may be used to carry out the present invention include, but are not limited to, propionic acid, acetic anhydride, acetic acid, etc., including combinations thereof.

Examples of aromatic organic solvents that may be used to carry out the present invention include, but are not limited to, mesitylene, cumene, p-xylene, toluene, benzene, etc., including combinations thereof.

Examples of hydrocarbon (i.e., aliphatic) organic solvents that may be used to carry out the present invention include, but are not limited to, cis-decalin, ISOPAR G, isooctane, methyl cyclohexane, cyclohexane, heptane, pentane, methylcyclopentane, 2-methylpentane, hexane, petroleum spirit, etc., including combinations thereof.

Examples of ether organic solvents that may be used to carry out the present invention include, but are not limited to, di(ethylene glycol), ethoxybenzene, tri(ethylene glycol), sulfolane, DEG monobutyl ether, anisole, diphenyl ether, dibutyl ether, t-amyl methyl ether, t-butylmethyl ether, cyclopentyl methyl ether, t-butyl ethyl ether, 2-methyltetrahydrofuran, diethyl ether, bis(2-methoxyethyl) ether, dimethyl ether, 1,4-dioxane, tetrahydrofuran, 1,2-dimethoxyethane, diisopropyl ether, etc., including combinations thereof.

Examples of dipolar aprotic organic solvents that may be used to carry out the present invention include, but are not limited to, dimethylpropylene urea, dimethyl sulphoxide, formamide, dimethyl formamide, N-methylformamide, N-methyl pyrrolidone, propanenitrile, dimethyl acetamide, acetonitrile, etc., including combinations thereof.

Examples of halogenated organic solvents (including hydrofluorocarbon solvents) that may be used to carry out the present invention include, but are not limited to, 1,2-dichlorobenzene, 1,2,4-trichlorobenzene, chlorobenzene, trichloroacetonitrile, chloroacetic acid, trichloroacetic acid, perfluorotoluene, perfluorocyclohexane, carbon tetrachloride, dichloromethane, perfluorohexane, fluorobenzene, chloroform, perfluorocyclic ether, trifluoracetic acid, trifluorotoluene, 1,2-dichloroethane, 2,2,2-trifluoroethanol, etc., including combinations thereof.

Examples of base organic solvents that may be used to carry out the present invention include, but are not limited to, N,N-dimethylaniline, triethylamine, pyridine, etc., including combinations thereof.

Examples of other organic solvents that may be used to carry out the present invention include, but are not limited to, nitromethane, carbon disulfide, etc., including combinations thereof.

Additional examples of wash liquids that can be used to carry out the present invention include, but are not limited to, those set forth in U.S. Pat. No. 10,343,331 to McCall, Rolland, and Converse, the disclosure of which is incorporated herein by reference in its entirety. Accordingly, hydrofluorocarbon solvents that may be used to carry out the present invention include, but are not limited to, 1,1,1,2,3,4,4,5,5-decafluoropentane (Vertrel XF, DuPont Chemours), 1,1,1,3,3-Pentafluoropropane, 1,1,1,3,3-Pentafluorobutane, etc. hydrochlorofluorocarbon solvents that may be used to carry out the present invention include, but are not limited to, 3,3-Dichloro-1,1,1,2,2-pentafluoropropane, 1,3-Dichloro-1,1,2,2,3-pentafluoropropane, 1,1-Dichloro-1-fluoroethane, etc., including mixtures thereof. Hydrofluorether solvents that may be used to carry out the present invention include, but are not limited to, methyl nonafluorobutyl ether (HFE-7100), methyl nonafluoroisobutyl ether (HFE-7100), ethyl nonafluorobutyl ether (HFE-7200), ethyl nonafluoroisobutyl ether (HFE-7200), 1,1,2,2-tetrafluoroethyl-2,2,2-trifluoroethyl ether, etc., including mixtures thereof. Commercially available examples of this solvent include Novec 7100 (3M), Novec 7200 (3M). Volatile methylsiloxane solvents that may be used to carry out the present invention include, but are not limited to, hexamethyldisiloxane (OS-10, Dow Corning), octamethyltrisiloxane (OS-20, Dow Corning), decamethyltetrasiloxane (OS-30, Dow Corning), etc., including mixtures thereof. And, inn some embodiments, the wash liquid comprises an azeotropic mixture comprising, consisting of, or consisting essentially of a first organic solvent (e.g. a hydrofluorocarbon solvent, a hydrochlorofluorocarbon solvent, a hydrofluorether solvent, amethylsiloxane solvent, or combination thereof; e.g., in an amount of from 80 or 85 to 99 percent by weight) and a second organic solvent (e.g., a C1-C4 or C6 alcohol such as methanol, ethanol, isopropanol, tert-butanol, etc.; e.g., in an amount of from 1 to 15 or 20 percent by weight). Additional ingredients such as surfactants or chelants may optionally be included. In some embodiments, the azeotropic wash liquid may provide superior cleaning properties, and/or enhanced recyclability, of the wash liquid. Additional examples of suitable azeotropic wash liquids include, but are not limited to, those set forth in U.S. Pat. Nos. 6,008,179; 6,426,327; 6,753,304; 6,288,018; 6,646,020; 6,699,829; 5,824,634; 5,196,137; 6,689,734; and 5,773,403, the disclosures of which are incorporated by reference herein in their entirety.

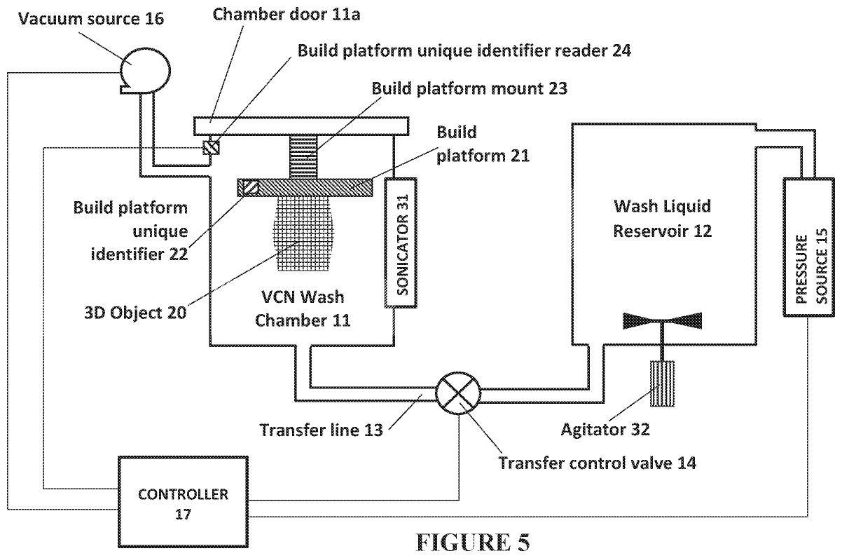

FIG. 5 schematically illustrates a non-limiting embodiment of an apparatus for carrying out VCN on additively manufactured objects, including: a wash chamber (11) (with associated chamber door (11a)); a wash liquid chamber or reservoir (12), and a wash liquid transfer line (13) interconnecting the two, and a vacuum source (16) operatively associated with the wash chamber. The transfer line can have a transfer control valve (14) operatively associated therewith, to open and allow wash liquid to transfer from one chamber to the other, and to close when the VCN process is being carried out, or the wash liquid is simply being stored in the liquid reservoir between wash cycles.

In the illustrated embodiment, a pressure source (15) such as compressed air or compressed nitrogen source is used to force liquid from the reservoir to the wash chamber, but transfer of liquid between the two chambers can be carried out by any suitable means, including but not limited to pumping, forcing with a compressed gas, vacuum, gravity flow, and combinations thereof.

A build platform mount (23) such as a clamp, receptacle or the like, configured for manual or automatic/robotic receiving of a build platform (21), can be included in the reservoir, either as a permanent or removable fixture. Note that the object (20) to be cleaned is optionally, but in some embodiments preferably (and as shown in FIG. 5) retained on its build platform for the VCN cleaning.

Resins such as dual cure resins can be prone to separation from the wash liquid. Accordingly, an agitator or sonicator (31) and/or (32) can be operatively associated with the chamber or reservoir to reduce the chance of resin separating from the wash liquid. Other energy sources, such as heaters, could optionally be included. Similarly, wash liquid contact surfaces of the wash chamber, the wash liquid reservoir, the wash liquid transfer line, and the control valve can include a fluoropolymer surface coating to reduce the adhesion thereto of residual resin (e.g., dual cure resins) carried by said wash liquid.

In some embodiments and as illustrated, the apparatus includes an identifier reader (24) (e.g., an NFC tag reader, an RFID tag reader or a bar code reader) operatively associated with the controller (17), and configured to receive information from each object to be washed as identified by a unique identifier (22) associated with each carrier platform (21) to which each object is adhered. In this case a unique identifier reader may also be included on the stereolithography (or other additive manufacturing) apparatus from which the build platform and objects were taken (not illustrated), so that information concerning the object made can be stored into memory, and a complete record of the manufacturing history for each object created and stored.

Also, while the Figures show the object (or objects) to be cleaned still retained on the build platform on which they were produced, the objects can be removed from their build platform and placed into or onto another appropriate carrier, such as a basket, for VCN cleaning. In such an embodiment a unique identifier may be included on the carrier or basket, and transfer of the objects may be accomplished on a transfer table also having a unique identifier reader, so that a digital record of the objects cleaned by VCN may be retained, consistent with the prior digital record for the additive manufacturing of the objects.

4. Further Curing after VCN.

In some cases, objects formed from conventional or “single cure” resins may be further cured after VCN cleaning, such as by flood cure under an ultraviolet light. This will typically be light at the same wavelength used to initially form the object by stereolithography.

Objects formed from dual cure resins are preferably further cured, after VCN, typically by an energy source or catalytic system different from that used to initially form the “green” object by stereolithography. In many embodiments, the further curing is by heating. Heating may be active heating (e.g., baking in an oven, such as an electric, gas, solar oven or microwave oven, or combination thereof), or passive heating (e.g., at ambient (room) temperature). Active heating (including in an inert atmosphere oven) will generally be more rapid than passive heating and is typically preferred, but passive heating—such as simply maintaining the intermediate at ambient temperature for a sufficient time to effect further cure—may in some embodiments also be employed.

### Examples 1-2

Two proof-of-principle experiments were performed to evaluate the use of vacuum cycle nucleation (VCN) to wash uncured resin from 3D-printed parts. The first experiment was intended to only evaluate the effectiveness of resin removal from challenging part geometries. The second experiment allowed investigation of both washing effectiveness and the properties of finished 3D-printed parts made from a dual cure resin after baking of those parts.

In both experiments, 99% isopropyl alcohol (IPA) as a wash liquid was first heated in a flask to a desired temperature using a heated water bath. Test samples were then submerged in the heated IPA inside the flask, and the flask was attached through a 3-way valve and a cold trap to a vacuum pump. To begin the wash process, the vacuum pump was used to lower the pressure in the flask below the wash liquid vapor pressure, nucleating vapor bubbles on the part. The 3-way valve was then manually operated to close the line to the vacuum pump and vent the flask to atmosphere, raising the pressure above the solvent vapor pressure and collapsing the vapor bubbles. By cycling the configuration of the 3-way valve, vapor bubbles were repeatedly nucleated and collapsed in approximately 5 second cycles throughout the washing process.

### Example 1

### VCN Cleaning of Resin from Pre-Formed Parts

In this example, a viscous elastomeric polyurethane dual cure additive manufacturing resin was manually injected into two pre-formed test samples to coat their internal and external surfaces. The first test sample was a finished 3D-printed elastomeric polyurethane part with a 3D lattice geometry, and the second sample was a coiled section of fluorinated ethylene propylene (FEP) tubing. The lattice test sample was washed for 5 minutes in 50° C. IPA while cycling the absolute pressure in the cleaning flask between approximately 110 and 140 mbar. The coiled tubing was washed in 50° C. IPA for 10 minutes while cycling the pressure between 110 and 140 mbar. After washing, the test samples were visually inspected, and nearly all of the uncured resin had been removed from both internal and external surfaces.

For comparison, the coiled tubing was again injected with resin, and washing was performed with an orbital shaker containing room temperature IPA for 15 minutes. Essentially no resin was removed from inside the tubing using the shaker, indicating the that the VCN process is more effective at cleaning viscous resin from restricted internal spaces.

### Example 2

### VCN Cleaning and Baking of Additively Manufactured Parts

In this example, two parts with 3D lattice geometries were produced by bottom-up stereolithography from a viscous elastomeric polyurethane dual cure additive manufacturing resin, and then washed by VCN while still in in the green state. The test samples were washed for 2 minutes in 40° C. IPA while cycling the absolute pressure between approximately 85 and 120 mbar. After the first wash, a significant amount of uncured resin remained on the parts, so they were washed for 5 more minutes at 45° C. with the same pressure cycling.

For comparison, two more parts were produced in like manner and washed by spinning the parts in room temperature IPA.

The parts from both washing processes were then air dried and baked under usual conditions. The experimental VCN process and the control process appeared to be similarly effective at washing resin from the internal and external surfaces of the test samples. No substantial deleterious effects were observed on the shape, integrity, or material properties of the parts that were washed with the experimental VCN process.

The foregoing is illustrative of the present invention, and is not to be construed as limiting thereof. The invention is defined by the following claims, with equivalents of the claims to be included therein.

1. A method of making an object from a data file and a light polymerizable resin by additive manufacturing, comprising the steps of:
(a) optionally (but in some embodiments preferably) modifying said data file to add additional vacuum cycling nucleation (VCN) nucleation sites to surfaces of said object;
(b) producing said object from said data file and said resin by light polymerization in an additive manufacturing process, optionally (but in some embodiments preferably) under conditions in which additional VCN nucleation sites are added to surfaces of said object, said object having residual resin adhered to the surface thereof, said residual resin being viscous and partially polymerized; and then
(c) cleaning said residual resin from said object with a wash liquid (e.g., an aqueous wash liquid or a wash liquid comprising an organic solvent) by vacuum cycling nucleation (e.g., at least one cycle of VCN, and in some embodiments 2 or 3 cycles of VCN to 10, 20 or 30 cycles of VCN),
wherein said object is produced from a dual cure resin, said dual cure resin resin comprising a mixture of (i) a light polymerizable liquid first component, and (ii) a second solidifiable component that is different from said first component; and said method further comprises the step, after said cleaning step, of:
(d) further curing said object (e.g., by heating, microwave irradiating, or a combination thereof).

2. The method of claim 1, wherein step (a) is included.

3. The method of claim 1, wherein said producing step is carried out with said object adhered to a carrier platform, and said cleaning step is carried out with said object adhered to said carrier platform without intervening separation therefrom.

4. The method of claim 1, wherein said cleaning step comprises:
(i) immersing the object in said wash liquid and subjecting the object to VCN;
(ii) separating the wash liquid from the object, and then optionally subjecting the object to a vacuum and/or heat, to and at least partially dry the object; and then
(iii) cyclically repeating steps (i) and (ii) until said object is cleaned.

5. The method of claim 1, wherein immersing of said object in wash liquid and/or separating of said wash liquid from said object is carried out by gravity draining, pumping, forcing with a pressurized gas (air, nitrogen, etc.), pulling with a vaccuum, or a combination thereof.

6. The method of claim 1, wherein said cleaning step comprises agitating said wash liquid (e.g., with a sonicator such as an ultrasound transducer).

7. The method of claim 1, wherein said wash liquid is at least partially saturated with carbon dioxide sufficiently to enhance bubble formation during VCN.

8. The method of claim 1, further comprising heating said object prior to said cleaning step, subjecting said object to increased pressure prior to said cleaning step, and/or heating said wash liquid for initial contact with said object during said cleaning step, to facilitate separation of resin from said object during said cleaning step.

9. The method of claim 1, wherein said cleaning step is carried out in a time of from 5 or 10 seconds or 1 minute, up to 2, 5, 10 or 20 minutes (i.e., as measured from initiation of the first immersing step, to completion of the final separating step).

10. The method of claim 1, wherein said producing step is carried out by bottom-up stereolithography (e.g., continuous liquid interface production or “CLIP”, optionally with at least a portion of said object being produced in reciprocal mode to impart additional VCN nucleation sites to surfaces of the object), top-down stereolithography, rolling film 3d printing, or multi-jet fusion 3d printing.

11. The method of claim 1, wherein said first component comprises monomers and/or prepolymers comprising reactive end groups selected from the group consisting of acrylates, methacrylates, α-olefins, N-vinyls, acrylamides, methacrylamides, styrenics, epoxides, thiols, 1,3-dienes, vinyl halides, acrylonitriles, vinyl esters, maleimides, and vinyl ethers.

12. The method of claim 1, wherein said second solidifiable component comprises the precursors to a cyanate ester resin, and wherein said wash liquid comprises an organic solvent (e.g., an alcohol, such as isopropanol, propylene glycol, or a combination thereof).

13. The method of claim 1, wherein said second solidifiable component comprises the precursors to an epoxy resin, and wherein said wash liquid comprises an organic solvent (e.g., a dibasic ester such as a dimethyl ester of adipic acid; an ether; an alcohol such as isopropanol, propylene glycol, or a combination thereof).

14. The method of claim 1, wherein said second solidifiable component comprises the precursors to a polyurethane, polyurea, or copolymer thereof, and said wash liquid comprises an organic solvent (e.g., an ether; an alcohol such as isopropanol, propylene glycol, or a combination thereof; etc.).

15. The method of claim 1, wherein said wash liquid comprises:
(i) at least 50 percent by volume isopropanol (e.g., in combination with up to 50 percent by volume water);
(ii) at least 20 or 40 percent by volume of a halogenated organic solvent (e.g., a hydrofluorocarbon solvent), in combination with up to 60 or 80 percent by weight of additional aqueous and/or organic solvents.

16. The method of claim 1, further comprising, following said cleaning step, the step of:
(e) distilling said wash liquid to produce a recycled wash liquid, and repeating step (c) with subsequently produced objects with said distilled wash liquid.

17. A vacuum cycling nucleation cleaning apparatus, comprising:
(a) a wash chamber;
(b) a wash liquid reservoir;
(c) a wash liquid transfer line interconnecting said wash chamber and said wash liquid reservoir, said transfer line having a control valve operatively associated therewith;
(d) a vacuum source operatively associated with said wash chamber;
(e) a stereolithography build platform engagement member operatively associated with said wash chamber and releasably engaging a build platform, the build platform having a unique identifier connected thereto;
(e) a unique identifier reader operatively associated with said wash chamber and positioned to communicate with said unique identifier,
wherein said apparatus is configured to clean residual resin from a surface of an object produced from a light polymerizable resin by light polymerization in an additive manufacturing process with a wash liquid by vacuum cycling nucleation (VCN), said residual resin being viscous and partially polymerized,
wherein said object is produced from a dual cure resin, said dual cure resin resin comprising a mixture of (i) a light polymerizable liquid first component, and (ii) a second solidifiable component that is different from said first component.

18. The apparatus of claim 17, said reservoir having an agitator operatively associated therewith (e.g., to prevent residual resin such as a dual cure resin previously removed from objects from separating from said wash liquid).

19. The apparatus of claim 17, wherein wash liquid contact surfaces of said wash chamber, said wash liquid reservoir, said wash liquid transfer line, and said control valve comprise a fluoropolymer surface coating to reduce the adhesion thereto of residual resin (e.g., dual cure resins) carried by said wash liquid.
